(19) United States
(12) Patent Application Publication
(10) Pub. No.: US 2005/0149910 A1
(43) Pub. Date: Jul. 7, 2005

(54) Portable and simplified scripting language parser

(76) Inventor: Raymond Joesph Prisament, Devon, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/979,840

(22) Filed: Nov. 1, 2004

Related U.S. Application Data
(60) Provisional application No. 60/516,521, filed on Oct. 31, 2003.

(51) Int. Cl. G06F 9/44

(52) U.S. Cl. 717/115

(57) ABSTRACT

A portable and simplified script parser and parsing method is provided. In the method, a function call within a script is recognized, and a determination is made as to whether a function corresponding to the function call is present within a function library. A default function is performed using the function call as an argument if no corresponding function is present, and a result is outputted.

### CROSS REFERENCE TO RELATED APPLICATION

This application claims priority under 35 U.S.C. § 119(e) from U.S. Provisional Application Ser. No. 60/516,521 (Attorney Docket No. FOSO-0002), which was filed with the U.S. Patent and Trademark Office on Oct. 31, 2003. The above-listed U.S. provisional application is incorporated by reference herein, in its entirety, for all purposes.

### FIELD OF THE INVENTION

The present invention relates generally to computer software. More particularly, the present invention relates to the parsing of a scripting language.

### BACKGROUND OF THE INVENTION

Software applications, including Web-based applications and dynamic Web sites, are programmed by software developers to perform certain tasks. The developer, however, cannot predict every way in which the eventual user(s) will want to use an application. Instead, the developer attempts to predict the most common uses of the application and provides functionality to accommodate those uses. Many situations require an application user to perform tasks that were not contemplated by the developer. In some situations, the desired task may involve a combination or sequence of tasks that the application cannot perform because it has not been configured to do so. This may be the case even in situations where the application could perform the combination and/or sequence of tasks if it was instructed properly.

Enabling such functionality is usually well beyond the computing abilities of the average user. In such instances, therefore, the user typically has to obtain the services of a trained developer to reengineer the application to provide the desired functionality by rewriting portions of the application code. Such a course of action is time-consuming because it usually requires the developer to review large amounts of application code to be able to implement the user's desired changes. In addition, the process usually requires extensive debugging to ensure that the developer has properly modified the application code to have the desired functionality and has not adversely affected other aspects of the application. As a result, reengineering application code to add functionality is often very expensive.

Furthermore, an application that has been reengineered to meet the needs of a particular user will quickly become unwieldy to maintain because only the developer who reengineered the application will be familiar with the idiosyncratic changes that were made. If the user wishes to update the application in the future, a different developer would likely have to take time to understand the modifications that were performed in the past before being able to perform the desired changes. This additional time therefore adds to the cost of future modifications.

As an alternative to rewriting the application code, the user may get a developer to create an Application Program Interface (API) or the like to interface with the application in the appropriate circumstances to provide the user's desired functionality. This method can also be expensive, and often requires the developer to have or acquire—at the user's expense—in-depth knowledge of the application. In addition, the developer may have to access critical portions of the application's code to get the API to work properly, which increases the chances that a developer error would have an adverse impact on the application. Furthermore, the time that is typically necessary to create an API having any level of sophistication also increases costs.

The limitations and drawbacks of existing application customization solutions may be explained in the context of a mass-emailing software application that permits a user to generate and send emails to a variety of customers. As noted above, developers build settings and options into applications to enable the application to be used in a number of situations, which reduces the need for reengineering. Thus, in the exemplary mass email application, the developer would likely provide a text box for the user to enter a desired message before sending. In such a way, the user could easily provide a customized message without having to become involved with the application's code. The user could change the message by changing the text in the text box.

While a text box may be sufficient for sending the same block of text to every customer, it can be seen that if the user wishes to send a letter that is personalized for each customer (e.g., with the customer's name), a more sophisticated approach should be taken. Instead of a simple text box, therefore, a script may be used. A script is a type of computer code than can be directly executed by an application, and does not need to be compiled into object code to be executed. A script parser takes a script and breaks the script into parts that can then be managed by the application or other software components. A parser may operate on the principle that the script should be output as text unless it recognizes an escape sequence. An escape sequence may be a special character (i.e., an “escape character”) or text that, when parsed, takes on a special meaning—such as to look up a value in a table or database, perform an arithmetic function, etc. For example, the developer may provide the sequence {LastName} in a script to look up and then output the last name of the customer when the message is sent. Thus, a user may use this escape sequence in combination with text to begin a message with the salutation “Dear Mr. or Ms. {LastName}),” where the {LastName} escape sequence would return the last name of the customer to whom the message is sent.

It can be seen that every message would begin with the text: “Dear Mr. or Ms.,” which is impersonal. Thus, the developer could therefore provide a {PrefixAndLastName} sequence that turns into a customer's title and name (e.g., “Mr. Smith” or “Ms. Jones”) when parsed. It can be seen, however, that the above example is just one of many possible user customization needs even within the present example of sending a mass email. In addition, the number and type of escape sequences provided by an application may depend on whether the developer accurately predicted the application features in which the user would be interested. For example, the {LastName} escape sequence may have seemed sufficient when the developer was creating the application, so the developer might not have provided the {PrefixAndLastName} sequence. In such a case, a user would require a method for customizing the application to perform the function of outputting a customer's title and name.

In the context of the above mass-emailing application example, it can be seen that as the user desires more sophisticated functionality, the chances of the user requiring a modification to the application increases. For example, the user may also want each customer's email to include a return policy for goods that have been purchased by the customer, where the return policy depends on the type of goods purchased. Conventionally in such a situation a user could simply use the application as it has been configured by inputting a return policy for every type of good and leave it to the customer to find the applicable policy in the resulting email. This solution would probably be disfavored because of the customer confusion that would result. Another conventional solution might involve developer reengineering of the code to provide an escape sequence that obtains an appropriate return policy from an entry in a database. This solution has the reengineering shortcomings discussed above, and would have to be repeated every time the user desired email content that could not be generated by existing escape sequences.

Ideally, an application user should have access to relevant data, and should have a means for manipulating that data as desired using a syntax that is as simplified as possible. Thus, a scripting framework should permit a user to create a script that has a higher level of sophistication, where new functions can be defined, and where logical and arithmetic functions may be performed as needed. Even if the user is not computer savvy enough to create a script having the desired level of functionality, the amount of work a developer would have to perform would be minimized because the developer would be able to work within the framework, thereby decreasing costs.

A conventional attempt to provide such a framework is to use existing features in programming languages that allow for the run-time parsing of code snippets in a script. For example, the PHP language has a function called eval( ), which takes a PHP code snippet as an argument and executes the code at run time. The Microsoft .Net platform has a similar capability. Unfortunately, the eval( ) function gives a script writer full access to all available functions of the underlying programming language. As a result, a user—or a developer unfamiliar with the details of the programming language—who attempts to create such a script may inadvertently cause serious problems with the application through ignorance or mistake. In addition, the eval( ) function requires the script to be written using the syntax and methods of the underlying language, which is usually intended for highly-trained software developers. Thus, the language may be unduly complicated for users or developers who are not very familiar with the language.

Thus, what is needed is a scripting framework that provides a means by which an application's functionality may be used in a custom fashion by a user. Particularly, what is needed is a script parser that enables in-line definition of functions to enable flexible use of application functionality. Even more particularly, what is needed is a portable object oriented script parser that provides a structured script parsing framework for any application operating within a particular object oriented environment.

### SUMMARY OF THE INVENTION

In light of the foregoing limitations and drawbacks, a method of parsing a script, a computer readable medium bearing computer executable instructions for parsing a script and a script parser are provided. An embodiment of the invention allows for client customization of settings, messages and other features in a software application. In the method, a function call within a script is recognized, and a determination is made as to whether a function corresponding to the function call is present within a function library. If no corresponding function is present, a default function is performed using the function call as an argument.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram illustrating a configuration of software components in which aspects of the invention may be implemented;

FIG. 2A is a flowchart illustrating an exemplary script parsing process according to an embodiment of the invention;

FIG. 2B is a flowchart illustrating an exemplary process used by a Function Call Node to decide which function to call according to an embodiment of the invention; and

FIGS. 3A-C are diagrams illustrating exemplary nodes that may be employed in connection with an embodiment of the invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the description that follows, it will be appreciated that details relating to programming language parsers should be known to those of skill in the art, and therefore such details are omitted herein for clarity. It will also be appreciated that embodiments of the invention are equally applicable to any computing language such as, for example, C#, C++, Java and the like. In addition, an embodiment is equally compatible with any object oriented environment such as, for example, NET, Java, etc. Furthermore, an embodiment may be applied to any type of computing device that is operating on a stand-alone or networked basis. For example, an embodiment may be implemented in a desktop computer, laptop, server or the like, which in turn may be operating alone or in connection with a network such as, for example, the Internet, an intranet, etc. The terminology of “object oriented programming,” such as classes, inheritance, objects and the like is used herein to represent generic object oriented concepts, and not specific implementations of those concepts in any particular programming language. Thus, it will be appreciated that any script syntax presented herein is for illustrative purposes only, as any syntax may be used in connection with an embodiment of the invention.

### Overview

In an embodiment of the invention, a script parser is provided. The script parser provides a user with a script reading engine that accepts simplified script syntax and can be used in connection with a variety of applications within an object oriented computing environment. In such an embodiment, the script parser provides functions that are selected by a developer or the like so as to be less likely to interfere with critical operations of the application with which the parser is being employed. In addition, an embodiment provides a script parser having one or more function libraries with a default function handler, whereby the name of the function itself becomes an input parameter (i.e., an argument) in the underlying function call. In such a manner, a user of the script parser is able to customize an application's functionality with a desired function, even if that function has not been previously defined.

As noted above, in an embodiment the script parser provides functions that are less likely to interfere with critical operations of an application. In such a manner, the access of the script writer to critical application functionality (i.e., functionality that, if tampered with, could cause the application to crash or otherwise operate improperly) is minimized. Nevertheless, in some embodiments any number of or type functions may be used, and any such number or type of functions is equally consistent with an embodiment. Furthermore, in some embodiments, the provided functions are tailored to the intended uses of the script parser, while in other embodiments the provided functions are applicable to a wide range of uses. Regardless of the presence or type of provided functions, an embodiment provides a user with an ability to supplement the provided functions with any number or type of function libraries. Thus, the user may add any number and type of functions to the application the user desires to customize.

In an embodiment, the language parsed by the script parser supports a sufficient set of features to achieve meaningful processing. For example, an embodiment supports various ways to assign and use variables, iterate through loops, perform arithmetic operations, evaluate IF/ELSE statements, and the like. Also, the language parsed by the script parser may be simplified and therefore well-suited to the most common customization tasks.

### Exemplary Embodiments

As noted above, an embodiment of the invention may be employed in connection with any type of object oriented environment. The implementation of an embodiment in connection with an object oriented environment permits a script parser, as will be described below, to take advantage of the interoperable nature of applications operating within the environment. Because the details of object oriented environments should be known to those of skill in the art, such details are omitted herein for clarity.

In addition, the various techniques described herein may be implemented with hardware or software or, where appropriate, with a combination of both. Thus, the methods and apparatus of the invention, or certain aspects or portions thereof, may take the form of program code (i.e., instructions) embodied in tangible media, such as a floppy disk, CD-ROM, CD-R, CD-RW, DVD, USB mass storage device, hard drive, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. In addition, an embodiment of the invention may be employed in a computing environment of any configuration.

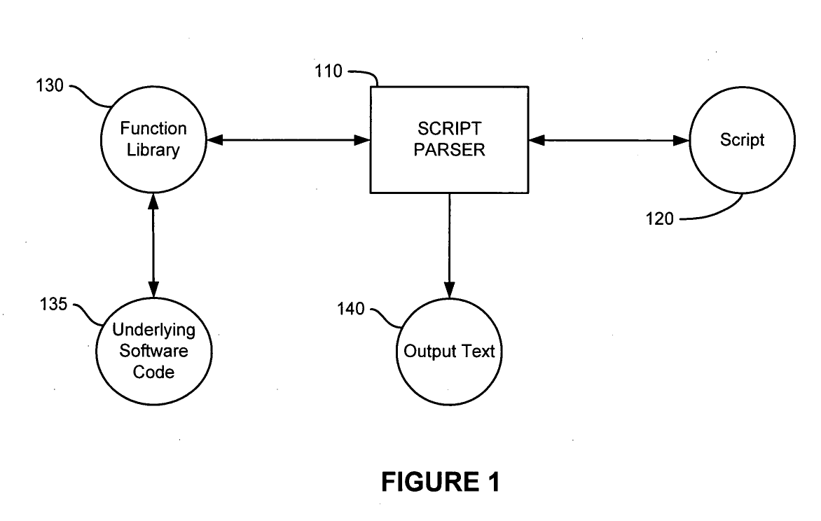

Turning now to FIG. 1, a block diagram illustrating a configuration of software components in which aspects of the invention may be implemented is presented. In FIG. 1, script parser 110 can be seen as the intermediary between script 120, output text 140, function library 130, and function library's 130 underlying software code 135.

According to an embodiment, script 120 is a user-defined textual input. Script parser 110 parses the script (as will be discussed in detail below) and calls functions from function library 130 as necessitated by script 120. It will be appreciated that any number of function libraries 130 may be provided. One or more function libraries 130 may be provided by script parser 110, by a software application (that may or may not be a software application with which script parser 110 interacts), by a user, etc. Thus, script parser 110 may be customized by a user to fit the user's needs. The function calls contained in function library 130 are supported by calls to the underlying software code 135 that performs the function. Thus, a user of script parser 110 need only know the name of a function to invoke the functionality of the function. Once the function has been performed, script parser 110 outputs text to an application that is being used.

It will be appreciated that because script parser 110 leverages the interoperable nature of applications that are operating within an object oriented environment, script parser 110 may provide a means for customizing application use for any application within its environment. Script parser 110 may therefore be compatible with any application operating within its object oriented environment.

As noted above, an embodiment of the invention provides a simplified interface that enables one or more default functions. The interface itself, in terms of the user interface that enables user input, may take any form. For example, a user interface of script parser 110 may provide graphical elements, text, pull-down menus, and the like. As may be appreciated, therefore, no particular configuration of a user interface is essential to an embodiment, as script parser 110 may have any type of user interface while remaining consistent with such an embodiment.

### Default Function Handling

Conventionally, a function call in a scripting language must reference a known, defined function. For example, a common function may be TRIM(string a), which removes extra white space from a text string. Thus, if the argument of a TRIM function is the following:

“Hello World ”

Then the TRIM function would return a result of:

“Hello World”

A conventional script parser, however, could only perform the TRIM function if it had already been explicitly defined in a function library. In contrast, and according to an embodiment, script parser 110 is able to process functions that have not already been explicitly defined by using a default function. This is not to say that an embodiment cannot process explicitly defined functions—rather, an embodiment can use both explicitly defined and default functions interchangeably. In addition, script parser 110 provides a simplified script syntax by way of a default function. In an embodiment, one or more function libraries 130 may contain a default function. When script parser 110 calls a function that has an unrecognized name (i.e., the function is not explicitly defined) function library 130 runs the default function instead of throwing an error, as would be done by a conventional script parser. In an embodiment, the default function provides the name of the unrecognized function as an argument.

For purposes of explanation, an example of an email confirmation message to be sent after the purchase on an e-commerce website will be discussed. It will be appreciated that an email application is just one of any number of applications that may be used in connection with an embodiment, and that the invention is in no way limited to email applications or e-commerce. Thus, the examples presented herein are in no way intended to limit embodiments of the invention to any particular type of application.

It will be appreciated that in the present example of a purchase confirmation email, the user may desire the email to display certain information. In addition, there may be many fields of data required for display such as, for example, the name of the product, the price, the confirmation number, the buyer's credit card number, etc. Such data may be made available to a user of the script parser 110 (e.g., a script writer) in the form of fields from a row in a database or the like. For example, in the C# object oriented programming environment, if a row in a database is assigned to a variable called data, the information may be available as data[“ProductName”], data[“Price”], etc. As may be appreciated, a database is not the only type of data storage application that may provide data to an embodiment. For example, spreadsheets, structured electronic documents and the like may also be used while remaining consistent with an embodiment.

Returning to the purchase confirmation email example, a user may wish to generate a customer purchase confirmation message that includes, for example, a statement saying:
Thank you for your purchase of (Product Name), which cost (Price).

Thus, it will be appreciated that in the present example Product Name and Price correspond to fields of data within a database or the like that may be made available to a script writer. A conventional solution for making such data available to a script writer is for a developer to expose a function, such as PurchaseInfo (fieldname f), where fieldname f takes the name of the field. The script writer then can write a script similar to:

Thank you for your purchase of << print
PurchaseInfo[“ProductName”]>>, which cost

<<print PurchaseInfo[“Price”]>>.

that will generate the desired statement. A shortcoming of such a conventional solution is the complexity of the syntax. For example, the square brackets and double quotes are familiar to high-level developers, but may be alien to less-experienced developers and end-users. It is therefore desirable to provide a script writer with a simpler syntax such as, for example:
Thank you for your purchase of <<print ProductName >>, which cost <<print Price >>.

The above syntax is more human-readable, and is therefore better-suited to less experienced developers and users. A conventional solution can typically only achieve such a level of simplified syntax by defining a unique function for every data element, or by providing a set of variables if the conventional script parser allows variables to be fed to the script from the application. The definition of a unique function may result in the following exemplary code in the software:

Function Price {

Return Data[“Price”]

}
Function ProductName {

Return Data[“ProductName”]

}

Unfortunately, such code would have to be written for every data element. It will be appreciated that such a method is inefficient because every function name relates directly to the data element requested from the function, and therefore the syntax is needlessly redundant. In addition, it can be seen that the software code could not assign a hard-coded function (or variable name) in scenarios in which the set of data elements is not well defined. For example, if the email application of the present example is flexible, every product may have “open fields” that may be given names and values by the owner. If a pet supply store uses the email software, they may call one of the open fields PetType, with the data indicating the type of pet for which a given product is intended. The owner of the pet supply store may desire the ability to write the following script:

We hope your <<print PetType>> will enjoy the <<print ProductName>>

to generate a sentence that says, when the appropriate values are retrieved from a database or the like:
“We hope your dog will enjoy the bone.”

Conventionally, a developer would be unable to provide the PetType function to a script writer because the developer had no way of knowing the PetType function would exist when programming the software. Thus, in a conventional system, a user would request that a developer provide the desired function before writing the script.

In contrast, an embodiment of the invention overcomes such an issue by using a default function. By using a default function, as provided by an embodiment of the present invention, the developer could write, for example:

Function DefaultFunction (string functionName, object[] args) {

Return Data[functionName];

}

It will be appreciated that the above code takes an otherwise undefined function (e.g., PetType) and, rather than throwing an error as would be the conventional course of action, obtains data from a data field having the same name as the function. Thus, the undefined user function PetType, when parsed by script parser 110, causes the default function handler to use the name of the undefined function, PetType, as a function argument to return data. The default function obtains a value of a PetType field in a data store such as a database, spreadsheet, formatted electronic document or the like. As should be known to one of skill in the art, one or more databases or other data stores may be made accessible to the script parser according to any appropriate object oriented protocol. Thus, new data fields or values within new data fields may be easily accessed according to an embodiment, because hard-coding the new function names is not required.

In addition, the above-discussed simplification of syntax is provided because functions do not have to be predefined, and therefore complex function calls do not need to be made in the syntax. A user of script parser 110 according to an embodiment may simply enter the undefined function to access data from a data field matching the name of the function. It will be appreciated that the default function is not limited to retrieving data, and may perform a different type of function with the undefined function as an argument. As a result, the default function may be tailored by a developer, user or the like to suit a particular purpose.

In addition, a default function is able to accept arguments just as any other function is able to do so. Thus, arithmetic, Boolean logic functions and the like may be performed in connection with a default function and its data result. Furthermore, the data being returned by a default function may be more complex than a single data value. For example, a consumer may have purchased multiple items. In that case, there is not just one ProductName and PetType, but instead multiple values—one for each purchased item—would be present for each data field. In an embodiment, therefore, a default function may be set to accept a parameter that is an index of the product within the purchase. By exposing another function called PurchaseCount (i.e., the number of customer purchases) the following script:

<<
print “Purchase Confirmation:”
loop $i from 1 to PurchaseCount {

print “Product #” $i “: “ ProductName($i)

}
>>
(Where $ denotes a variable name.)
This may result in output such as:
Purchase Confirmation:
Product # 1: Dog Food
Product # 2: Cat Chow
Etc.

Thus, a default function handler according to one embodiment, with one parameter, allows for the simplified script syntax above to perform the user's desired function.

### Application Customization Examples

The discussion to follow describes aspects of the operation of script parser 110 used in connection with an embodiment of the invention. It will be appreciated that such embodiments may be used to customize applications to perform a variety of user-defined functions. For the sake of context, a few examples of such customization are presently discussed. The present examples are in no way exhaustive, as an embodiment may be used to implement any type of user customization to any type of application operating in an object oriented environment.

For example, an embodiment may be used in connection with an online data reporting system, where a user may desire an arithmetic function to be performed on the retrieved data. For example, data elements in such a reporting system may have user-defined names, such as Revenue and Expenses, that have data values in various years (e.g., 2002, 2003, 2004) and various business segments (e.g., Operations, HR, Executive, etc.). A default function handler may be used to determine profit (i.e., Revenue minus Expenses) in 2002 in the Operations division by writing a simplified script such as, for example:

<<print Revenue (2002, “Operations”) - Expenses (2002, “Operations”)>>

Thus, it will be appreciated that an embodiment may handle complex data elements that have multiple values, and may permit arithmetic functions to be performed on such data. In another example, a user may desire a welcome message on a web site to change according to the time of day (e.g., “good morning” in the morning, etc.). According to an embodiment, a script to accomplish such a function could be written as:

<<if IsMorning { print “Good Morning” } else { print
“Good Afternoon.” } >>

In yet another example, a user may desire that values presented inside a data display be customized row-by-row. For example, in a phone book application, the user can search entries by various criteria and then matching entries are presented in a result list. A user may wish to be able to customize the fields in the result list so that the entries display only fields of the entries that are of interest to the user. Thus, a user may wish to see a last name, first name and home phone number for each entry, while another user may wish to see a last name, first name and work phone number. According to an embodiment, a preferred phone number column (e.g., using a PreferredPhone data entry) could be defined by the following exemplary script:

<< if PreferredPhone = “Home” { print HomePhone }
else { print WorkPhone } >>

Again, it will be appreciated that the above examples are in no way an exhaustive list of all embodiments of the invention. Rather, the above examples are used merely to illustrate the variety of applications in which an embodiment may be employed. Accordingly, one of skill in the art will recognize that an embodiment may be used to enable a wide range of functionality across a wide range of software applications.

### Exemplary Script Parser

Now that a few illustrative examples of possible implementations of an embodiment have been presented for the sake of context, exemplary methods for implementing script parser 110 and its corresponding simplified script syntax will now be discussed. An embodiment of the invention provides two public classes to its object oriented environment: a parser class and an abstract class. The parser class accepts a named collection (i.e., a dictionary) of function libraries, where each library is assigned a string prefix that identifies that function library to the script writer if there is more than library available. For example, in one embodiment the script writer could reference a function named fn from a function library prefixed lib by writing:

lib:fn( );

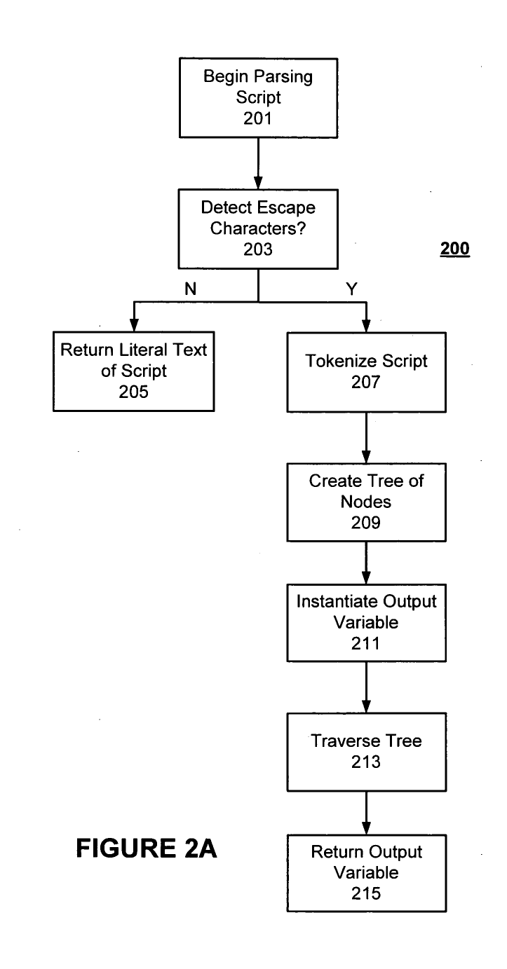

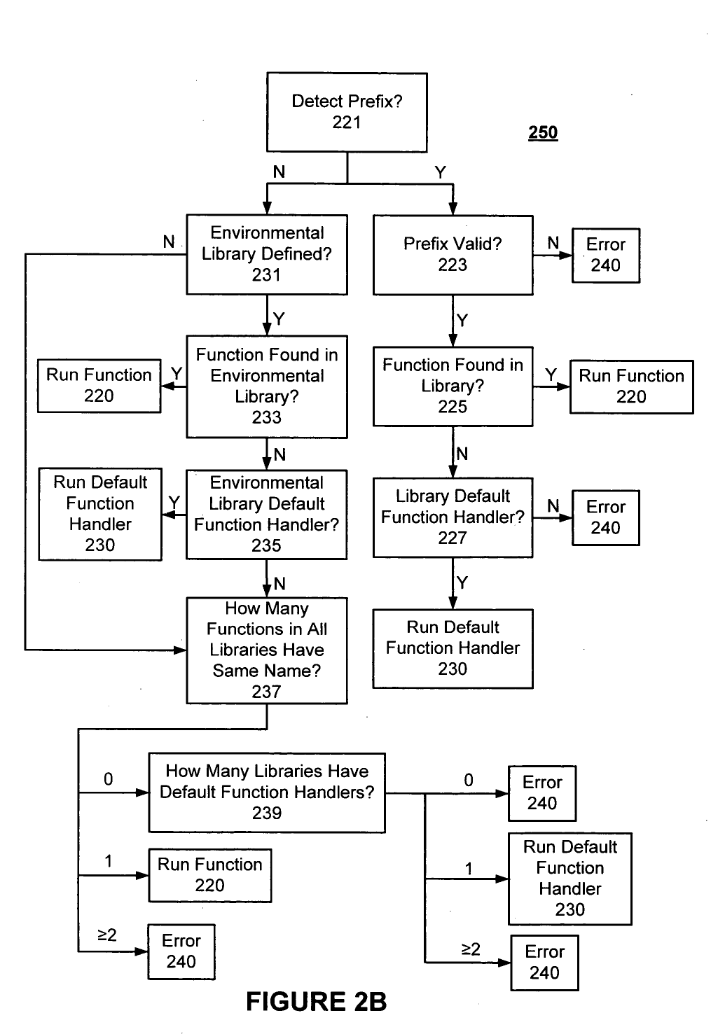

In addition, an embodiment provides that one library, referred to herein solely for the sake of clarity as the environmental library, may have priority over other libraries. The member functions of the environmental library may be referenced by the script writer without use of a prefix. The parser class also accepts an input string, which is the script to be parsed. The abstract class is a class from which the function libraries are inherited. In addition, the script to be parsed may contain a Function Call Node, which represents a call to a function. In an embodiment, when script parser 110 encounters a Function Call Node while parsing a script, parser 110 follows a decision tree to determine which function to call, as described below in connection with FIG. 2B.

It will be appreciated that for a script parser 110 of an embodiment to operate, certain software components may need to be defined. For example, a standard function delegate (e.g., a function pointer) may be defined using, for example, the following exemplary signature:

Object DelegateName (Object[] params)

In addition, an embodiment may need to define a default function delegate (e.g., a default function pointer) using, for example, the following exemplary signature:

Object DelegateName (string FnName, Object[] params)

An embodiment may also need to define an abstract, parent class for all function libraries. The parent class may have a dictionary of name/value pairs, in which the name is the function name and the value is the method relating to that function name. In addition, the parent class may have a method by which child classes may add to the dictionary, and a single variable that represents the default function handler, which is a method with the above “default function” signature. In addition, and as described above, parser 110 itself may contain a dictionary of name/value pairs defined so that the names are “prefixes” assigned to the member function libraries and the values are the libraries themselves. One prefix may be reserved for the environmental library and another may be reserved for a native function library.

The native function library, in one embodiment, may be included with every instance of script parser 110. The native function library may include the core functionality needed to make parser 110 meaningful, such as for example arithmetic functions (e.g., addition, subtraction, etc.) and string concatenation. For example, the ADD function (e.g., which adds only two numbers) may be present within the native function library and could be provided by the following exemplary code:

Object Add (Object[] params) {

If (params.Count > 2)

Throw error “Too many parameters”

Return params[0] + params[1]

}

It can be seen that the above code throws an error in the event that more than two numbers are present and outputs the text message “Too many parameters.” Thus, it will be appreciated that script parser 110 may have the ability to perform arithmetic functions and the like.

In an embodiment, a parser object may be present, and the parser object may contain a function library dictionary as described above. According to such an embodiment, a method of the parser object named, for example, Parse may have the exemplary signature:
string Parse (string script)

This method may accept the script as input, break the script into a character array to seed a tokenizer object, parse the script into nodes of a tree and then traverse the tree to create textual output that it then returns. The tokenizer object may be an internal class that is used as a tool to proceed through the script. The method of building a parse tree from an input script using a tokenizer or other similar tool, and then traversing that tree to execute functionality should be familiar to one of skill in the art. Accordingly, only a limited discussion of such matters is discussed herein for clarity. Furthermore, it will be appreciated that the terms “parse tree” and “node tree” are used herein interchangeably. In an embodiment, the tokenizer may look through a script in a character-by-character manner as needed to facilitate parsing. The tokenizer may also maintain a position within the script and may only move forward from that position.

The tokenizer object may contain methods to perform such functionality, such as for example a Tokenize Until (string[] ends With) method, which may “consume” the script until it reaches a requested ending string. For example, after the start of a comment—that may begin with a “#” symbol—the parser may call TokenizeUntil (‘#’) to consume the script until it reaches the end of the comment. The TokenizeUntil method may return as output a BodyToken, which is the text between where the tokenizer began and where the tokenizer ended when it reached an Ends With string. In addition, the TokenizeUntil method may return as output an EndToken, which is a string representing the ending string matched by the tokenizer.

Another tokenizer function may be Peak (int i). This function “peaks” forward I characters and returns the string represented by the next I characters, without consuming those characters. Yet another tokenizer function may be IncrementIndex (int i). This function moves the tokenizer's position within the script forward I characters. Both the Peak and IncrementIndex functions may be instructed to IgnoreProceedingWhitespace, in which case the count I does not begin until the first non-whitespace character.

In an embodiment, every node is an instance of a class. An instance of the appropriate class is created by the parser as it reads through the script, creating a node tree as should be familiar to one of skill in the art. In such an embodiment, script parser 110 uses the tokenizer to move character-by-character through the script and create a tree of nodes. Such a process is described generally below in connection with FIG. 2A. An exemplary process used by a Function Call Node of the parser to decide which function to call is described below in connection with FIG. 2B.

FIG. 2A, at step 201, illustrates an exemplary script parsing method 200. Script parsing method 200 may be initiated at step 201 by way of a user command, automatically upon the occurrence of a triggering event, or the like. In one embodiment the parser, such as for example script parser 110 as discussed above in connection with FIG. 1, is configured to understand escape characters in the script. The escape characters indicate the boundaries between portions of the script that the script writer wishes to be returned as literal text and areas that the script writer wishes to be read as instructions. The concept of escape characters will be familiar to those skilled at using Web scripting languages such as ASP, PHP or the like. In the examples used herein, the escape characters are the double less-than and double greater-than characters (“<<” and “>>”); however, this should not be construed to imply that the use of those particular characters is required, as any type of escape character(s) are consistent with an embodiment of the invention. At step 203, a determination is made as to whether an escape character sequence is detected at any point in the script. If not, the literal text of the script is returned (i.e., sent to the application) at step 205.

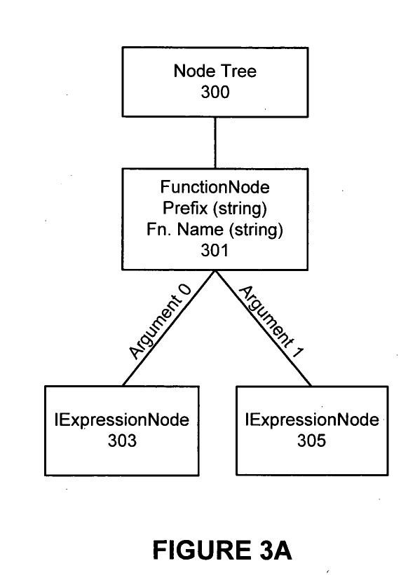

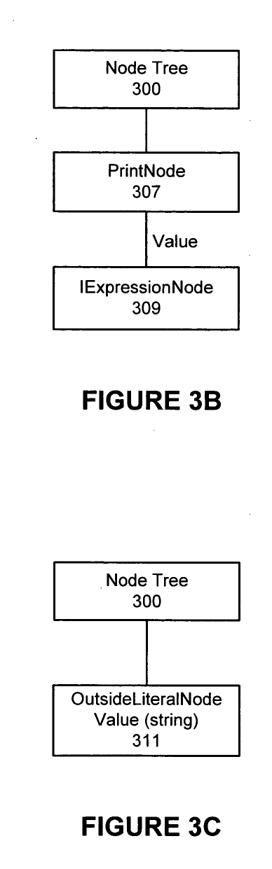

If the determination of step 203 is that an escape character sequence has been found, method 200 proceeds to step 207, where the script is tokenized in, for example, a manner using the tokenizer as discussed above. At step 209, a tree of nodes is created. Generally, the addition of nodes to a parse tree should be familiar to one of skill in the art. Exemplary nodes that may be used in connection with an embodiment of the invention will be discussed below in connection with FIGS. 3A-C. At step 211, an output variable that will contain the output text is instantiated. The output variable is capable of holding a string of unspecified length. For example, in one embodiment that may be built using the Microsoft .Net platform, the output variable may be represented as an instance of the System.Text.StringBuilder class. At step 213, the node tree is traversed, and the output variable updated as called for by, for example, any instances of the nodes discussed in FIGS. 3A-C. At step 215, the output text is returned to the application.

As may be appreciated, FIG. 2B is a more detailed view of the actions at node 213 when, during the traversing of the tree, a function node is reached. Thus, FIG. 2B illustrates an exemplary method used by a Function Call Node to decide which function to call. Generally, and according to an embodiment, a Function Call Node may contain several items such as, for example, a function prefix, a function name and a collection of Expression Nodes that are parameters for the function. Every item in this collection may be evaluated and the resulting values put into an object array. Once the Function Call Node has identified the function to call, it may find the appropriate function library in the function library collection. If the default function is not being called, the Function Call Node finds the appropriate function to run by looking up the function's name in the library's dictionary. The Function Call Node then runs that function, passing in the object array.

Turning now to the exemplary function calling method 250 of FIG. 2B, at step 221 a determination is made as to whether a function call prefix has been detected. If so, method 250 proceeds to step 223, where a determination is made as to whether the prefix is valid and, if not, method 250 throws an error at step 240. If the determination of step 223 is that the prefix is valid, then method 250 proceeds to step 225 where a determination is made as to whether the function is found in a function library. If the function was found, the function is run at step 220. If the function was not found in a library, a determination is made at step 227 as to whether a default function is present. If there is no default function handler present, then method 250 throws an error at step 240. If a default function handler is present, then at step 230 the default function handler is run. It will be appreciated that in an embodiment the default function handler may be configured as discussed above.

If the determination of step 221 was that a prefix was not detected, thereby possibly indicating a function call to the environmental library, then at step 231 a determination is made as to whether an environmental library has been defined. As noted above, an environmental library is a function library that has been given priority over one or more other function libraries. If an environmental library has been defined, then at step 233 method 250 determines whether the function is found in the environmental library. If the function was found, then the function is run at step 220. If the function was not found in the environmental library, then at step 235 a determination is made as to whether an environmental library default function handler is present. If the environmental library default function handler is present, then at step 230 the default function handler is run. If the environmental library default function handler is not present, then at step 237 a determination is made as to how many functions in all libraries have the same name as the function being processed. Also, it can be seen that method 250 proceeds to step 237 directly if the determination of step 231 was that no environmental library was defined.

Method 250 may then proceed to either step 239, 220 or 240 depending on the determination of step 237. For example, if the determination of step 237 was that no functions in all libraries have the same name as the function being processed, then at step 239 another determination is made as to how many libraries have default function handlers. If no library has a default function handler, then at step 240 method 250 throws an error. If the determination is that one library has a default function handler, then at step 230 that default function handler is run. Finally, if two or more libraries have default function handlers, at step 240 an error is thrown.

If the determination of step 237 was that one function in all libraries has the same name as the function being processed, then method 250 runs the function at step 220. If the determination of step 237 was that two or more functions in all libraries have the same name as the function being processed, then method 250 throws an error at step 240.

FIGS. 3A-C are diagrams illustrating exemplary nodes that may be added to a parse tree if called for in a script in accordance with an embodiment of the invention. FIG. 3A illustrates block 300 representing any appropriate location in a parse tree that could serve as a parent to exemplary Function Call Node 301. As noted above, a Function Call Node such as Function Call Node 301 may have a minimum of two string properties, such as a prefix and a name. It will be appreciated that the prefix may be an empty string if none was provided by the script writer. In addition, the function node may have zero or more ordered child Expression Nodes, such as Expression Nodes 303 and 305. Expression Nodes 303 and 305 represent the parameters passed into the function by the script writer. In addition, the term “expression node” refers to any node that can be evaluated to return a value, such as for example literal text nodes, or a variable node. In an embodiment, such arguments may be maintained in an ordered collection such an array. It will be appreciated that while Function Call Node 301 has two arguments (i.e., nodes 303 and 305), a Function Call Node in general may have any number of arguments, including zero arguments. It will also be appreciated that while the arguments of Expression Nodes 303 and 305 are shown as leaf nodes in FIG. 3A, an argument may in turn have any number and/or type of child nodes that may, for example, be Function Call Nodes.

FIGS. 3B and 3C illustrate diagrams of two exemplary nodes that write to the parser's output variable. In FIG. 3B, block 300 represents any appropriate location in a parse tree that could serve as a parent to Print Node 307. Print Node 307 represents an explicit call by the script writer to print to the output variable. In one embodiment, such an explicit call may be written in the script as, for example:

Print “hello”;

It will be appreciated that, as noted above, the exact syntax used by a script writer may vary, and any such syntax is consistent with an embodiment. In an embodiment, and as noted above, a distinct escape character sequence may exist for the script writer's use. Such an escape character sequence (in addition to the standard syntax provided for creating a print node) may be parsed into, for example, Print Node 307. By way of example, the Print Node 307 and Expression Node 309 could be created, in an embodiment, either by the exemplary syntax shown above or by the syntax:

<<=“hello”>>

Again, it will be appreciated that while a distinct escape character sequence is represented above as “<<=” and “>>”, any character or combination of characters that may comprise a distinct escape character sequence is equally consistent with an embodiment. As can be seen in FIG. 3B, Print Node 307 has one child node that is Expression Node 309. Expression Node 309 represents a value to be printed to the output text. In the above example, the value would take the form of a literal text node with a value of “hello.” When called during the traversing of the node tree, therefore, Print Node 307 will append the evaluated value of Expression Node 309 to the script parser's output variable.

FIG. 3C is a diagram illustrating an exemplary structure of Outside Literal Node 311, which represents text from the script that is outside of escape characters and intended by the script writer to be returned literally. As was the case with FIGS. 3A-B above, block 300 represents any appropriate location in a parse tree that could serve as a parent to Outside Literal Node 311. In FIG. 3C, it can be seen that Outside Literal Node 311 has one property, which is the value of the text to be returned. When called during the traversing of the node tree, Outside Literal Node 311 appends the value of its “value” property to the parser's output variable.

### Exemplary Implementation

Now that the operation of an embodiment of the invention has been discussed, for purposes of further explanation an example of one possible application of script parser 110 according to such an embodiment is presented. It will be appreciated that the present example is in no way limiting as an embodiment may be employed in a variety of contexts and in connection with a variety of applications, as was noted above.

In the present example, an e-commerce Web site shows a confirmation screen after a customer makes a purchase. The confirmation screen lists the customer's purchases, the Web site's return policy and/or any other applicable information. Practical considerations may require that the confirmation message change on a regular basis. Thus, a developer or user would not wish to hard-code the confirmation page. Instead, in the present example a description of an exemplary process of setting up a script parser by a developer or the like, and then use of the script parser by a user, is discussed.

Accordingly, a script parser according to an embodiment may be used to provide the desired functionality without the need for hard-coding the confirmation page into the application. Again, it should be appreciated that in the discussion that follows the object oriented language examples are merely illustrative, as any object oriented language and/or syntax may be used while remaining consistent with an embodiment.

For purposes of the present example, it is assumed that a string called ConfirmationPageScript holds the current script for the confirmation page. The script may be set by, for example, by way of a text box on a Web site application page. In addition, it is assumed that data regarding the products that were purchased by the consumer have been compiled into a 2-dimensional collection called PurchaseInfo, in which the first dimension is the index of a particular item within the purchase, and the second dimension is the various named aspects of that item. It will be appreciated that the PurchaseInfo data structure is not required by a parser according to an embodiment.

Thus, if a consumer purchases one ski jacket and one pair of ski boots, the collection of PurchaseInfo could look like:

PurchaseInfo[0][“ProductName”] = “Ski Jacket”
PurchaseInfo[0][“Price”] = 50.00
. . . . Etc.
PurchaseInfo[1][“ProductName”] = “Ski Boots”
PurchaseInfo[1][“Price”] = 100.00
. . . . Etc.

Thus, a developer or the like could first create a needed function library, such as for example by using the following pseudo-code:

Public class ConfScreenLibrary extends FunctionLibrary {

/* Member variables */

Protected Collection MyPurchaseInfo
Protected string UserName

/* Constructor */

Public ConfScreenLibrary (Collection thePurchaseInfo,
string theUserName) {

MyPurchaseInfo = thePurchaseInfo
UserName = theUserName
/* SetDefaultHandler is a function defined
in the parent class */
SetDefaultHandler (OnDefaultFunction)
/* Add the named functions */
Add (“PurchaseCount”, PurchaseCountFunction)
Add (“UserName”, UserNameFunction)

}

/* Below are the actual function definitions. */

Public Object OnDefaultFunction (String fnName, Object[] params) {

If there is more than 1 parameter {

Throw error “You may not set more than one
parameter.”

}
Integer index = params[0]
Return MyPurchaseInfo[index][fnName];

}
Public Object PurchaseCount (Object[] params) {

If there are any parameters {

Throw error “You may not set any parameters
on the PurchaseCount

function.”

}
Return count of MyPurchaseInfo

}
Public Object UserName (Object[] params) {

If there are any parameters {

Throw error “You may not set any parameters on the
UserName function.”

}
return UserName

}
}

In addition to the functions contained in the above function library, the developer may wish to give the script writer access to additional functions as well—such as date and/or time information. Thus, it is assumed for the purposes of the present example that a DateInformationLibrary is already available. If such a library is not available, it will be appreciated that such a library could be programmed in a similar manner to the above library. It is also assumed that DateInformationLibrary has no default function handler, but has functions defined for “Day,” “Month” and “Year,” which return the current day, month and year, respectively.

Once the above libraries are established, the parser could be instantiated and the function libraries assigned, which may involve code such as the following:

Parser myParser = new Parser( )
myParser.SetEnvironmentLibrary ( new ConfScreenLibrary
(PurchaseInfo, UserName))
myParser.Libraries.Add (“d”, new DateInformationLibrary)

As may be appreciated, the above lines of code have the effect of instantiating a parser and assigning the libraries. In particular, an instance of the ConfScreenLibrary is instantiated with the PurchaseInfo collection and the UserName string, and set as the environmental library. By setting ConfScreenLibrary as the environmental library, the script writer will be able to use its functions without prefixing them. The DateInformationLibrary is also instantiated and added to the collection, and is assigned the prefix “d.” Thus, in certain cases, if the script writer wishes to access the functions of the DateInformationLibrary library, function calls should be prefixed with d:, such as for example d:Month.

The script may now be parsed to obtain output, which may involve the following code to instruct the parser to parse the script and output the result(s).

String output=Parser.Parse (ConfirmationPageScript)

At this point, the developer has effectively completed with his or her work, as the script parser is ready for the user to enter a script. It will be appreciated that the relatively difficult programming tasks have already been completed, and therefore the user may use a simplified syntax when writing the script. For example, one potential script (with the necessary HTML tags removed for clarity) that could use the above libraries and parser may be:

Thank you <<UserName>> for your purchase!
You bought the following <<=PurchaseCount>> items:
<<
loop $i from 0 to PurchaseCount {

print ProductName(i) “ which cost ” Price (i)

}
>>
Today's date is <<=d:Month>><<=d:Day>>, <<=d:Year>>
Please remember our return policy, which is . . .
***

As may be appreciated, the calls to the functions ProductName(i) and Price(i) will invoke the default function handler in the environmental library. The calls to d:Month, d:Day and d:Year are functions in the DateInformationLibrary. In the present example, such function calls would still work even if the d: prefix were not used, because no other function libraries contain those function names. However, recalling method 200 discussed above in connection with FIG. 2A, it can be seen that the d: prefix would likely be necessary to activate the default function handler on the DataInformationLibrary, if such a default function handler were present.

### Conclusion

Thus, a portable and simplified scripting language parser has been provided. While the present invention has been described in connection with the exemplary embodiments of the various figures, it is to be understood that other similar embodiments may be used or modifications and additions may be made to the described embodiment for performing the same function of the present invention without deviating therefrom. For example, one skilled in the art will recognize that while the present invention was described in the present application in the context of using the C# language in a NET environment, the present invention may apply to any type or configuration of computing language in any type of application environment. Therefore, the present invention should not be limited to any single embodiment, but rather should be construed in breadth and scope in accordance with the appended claims.

1. A method of parsing a script, comprising:
recognizing a function call within the script;
determining whether a function corresponding to the function call is present within a function library; and
performing a default function using the function call as an argument if no corresponding function is present within the function library.

2. The method of claim 1, wherein said determining step further comprises determining whether a function corresponding to the function call is present within one of a plurality of function libraries.

3. The method of claim 2, wherein one of the plurality of function libraries has priority over other of the plurality of function libraries, and wherein said performing step further comprises performing the default function using the function call as an argument if no corresponding function is present within the function library having priority.

4. The method of claim 3, wherein the function library having priority is an environmental library.

5. The method of claim 2, wherein said recognizing step comprises determining whether a prefix is present with the function call.

6. The method of claim 5, wherein said determining step comprises searching for the corresponding function in a function library having priority over other of the plurality of function libraries for the corresponding function if the prefix is not present with the function call.

7. The method of claim 5, wherein said determining step comprises searching one of the plurality of function libraries that is designated by the prefix if the prefix is present with the function call.

8. The method of claim 2, further comprising performing the default function using the function call as an argument if no corresponding function is present within any of the plurality of function libraries.

9. The method of claim 1, wherein a result of the script parsing is outputted to an object-oriented application.

10. The method of claim 9, wherein the function library is provided by the object-oriented application.

11. The method of claim 1, wherein said recognizing step comprises detecting an escape character in the script.

12. The method of claim 1, further comprising performing the function corresponding to the function call if the corresponding function is present within the function library.

13. The method of claim 1, wherein said performing step comprises retrieving data from a data field in a data store, wherein the data field matches the argument of the default function.

14. The method of claim 13, wherein the data store is one of a database, spreadsheet or structured electronic document.

15. The method of claim 1, further comprising recognizing text within the script and outputting the text.

16. The method of claim 1, further comprising tokenizing the script.

17. The method of claim 16, wherein the script comprises characters, and wherein tokenizing the script comprises proceeding through each character of the script, returning a node if a function corresponding to the function code is present within the function library and creating a tree having the returned node.

18. The method of claim 17, further comprising traversing the tree, and wherein said performing step takes place when the returned node is traversed in the tree.

19. The method of claim 1, further comprising outputting an error if more than one function corresponding to the function call is present within the function library.

20. The method of claim 1, further comprising selecting the function library.

21. A script parser comprising:
a function library having a function and a default function;
a parser object for parsing a script and recognizing a function call within the script; and
a native function library for providing at least one native function, wherein the at least one native function determines whether the function call corresponds to the function in the function library, and wherein
the default function processes the function call as an argument if the at least one native function determines that the function call does not correspond to the function in the function library.

22. The script parser of claim 21, wherein the one native function further determines whether the function corresponding to the function call is present within one of a plurality of function libraries.

23. The script parser of claim 22, wherein one of the plurality of function libraries has priority over other of the plurality of function libraries, and wherein the default function further processes the function call as an argument if no corresponding function is present within the function library having priority.

24. The script parser of claim 23, wherein the function library having priority is an environmental library.

25. The script parser of claim 22, wherein the parser object recognizes the function call by determining whether a prefix is present with the function call.

26. The script parser of claim 25, wherein the at least one native function further searches for the corresponding function in one of the plurality of function libraries that has priority over other of the plurality of function libraries if the prefix is not present with the function call.

27. The script parser of claim 25, wherein the at least one native function further searches one of the plurality of function libraries that is designated by the prefix if the prefix is present with the function call.

28. The script parser of claim 22, wherein the default function processes the function call as an argument if no corresponding function is present within any of the plurality of function libraries.

29. The script parser of claim 21, wherein the default function further outputs a result of the script parsing to an object-oriented application.

30. The script parser of claim 21, wherein the parser object recognizes a function call by detecting an escape character in the script.

31. The script parser of claim 21, wherein the function library is provided by the object-oriented application.

32. The script parser of claim 21, wherein the parser object determines whether a prefix is present with the function call.

33. The script parser of claim 21, wherein, if the function call corresponds to the function in the function library, the function is run and outputs a result of the function.

34. The script parser of claim 21, wherein the script parser is in operative communications with a data store, and wherein the default function processes the function call by retrieving data from a data field in the data store, wherein the data field matches the argument of the default function.

35. The script parser of claim 34, wherein the data store is one of a database, spreadsheet or structured electronic document.

36. The script parser of claim 21, wherein the parser object further recognizes text within the script and outputs the text.

37. The script parser of claim 21, wherein the script comprises characters, and wherein the parser object proceeds through each character of the script, returns a node if the at least one native function determines that a function in the function library corresponds to the function call, and creates a tree of the returned node.

38. The script parser of claim 37, wherein the parser object traverses the tree, and wherein the function is run and outputs a result when the returned node is traversed in the tree.

39. The script parser of claim 21, wherein the at least one native function outputs an error if the function call corresponds to more than one function in the function library.

40. A computer readable medium bearing computer executable instructions for carrying out the method of claim 1.

41. The computer readable medium of claim 40, wherein said determining step further comprises determining whether a function corresponding to the function call is present within one of a plurality of function libraries.

42. The computer readable medium of claim 41, wherein one of the plurality of function libraries has priority over other of the plurality of function libraries, and wherein said performing step further comprises performing the default function using the function call as an argument if no corresponding function is present within the function library having priority.

43. The computer readable medium of claim 42, wherein the function library having priority is an environmental library.

44. The computer readable medium of claim 41, wherein said recognizing step comprises determining whether a prefix is present with the function call.

45. The computer readable medium of claim 44, wherein said determining step comprises searching for the corresponding function in the function library having priority over other of the plurality of function libraries if the prefix is not present with the function call.

46. The computer readable medium of claim 44, wherein said determining step comprises searching for the corresponding function in one of the plurality of function libraries that is designated by the prefix if the prefix is present with the function call.

47. The computer readable medium of claim 41, wherein the method further comprises performing the default function using the function call as an argument if no corresponding function is present within any of the plurality of function libraries.

48. The computer readable medium of claim 40, wherein the method further comprises outputting a result of the script parsing to an object-oriented application.

49. The computer readable medium of claim 40, wherein the function library is provided by the object-oriented application.

50. The computer readable medium of claim 40, wherein recognizing a function call within the script comprises detecting an escape character in the script.

51. The computer readable medium of claim 40, wherein the method further comprises performing the function corresponding to the function call if the corresponding function is present within the function library.

52. The computer readable medium of claim 40, wherein said performing step comprises retrieving data from a data field in a data store, wherein the data field matches the argument of the default function.

53. The computer readable medium of claim 52, wherein the data store is one of a database, spreadsheet or structured electronic document.

54. The computer readable medium of claim 40, wherein the method further comprises recognizing text within the script and outputting the text.

55. The computer readable medium of claim 40, wherein the method further comprises tokenizing the script.

56. The computer readable medium of claim 55, wherein the script comprises characters, and wherein tokenizing the script comprises proceeding through each character of the script, returning a node if a function corresponding to the function code is present within the function library and creating a tree having the returned node.

57. The computer readable medium of claim 56, wherein the method further comprises traversing the tree, and wherein said performing step takes place when the returned node is traversed in the tree.

58. The computer readable medium of claim 40, wherein the method further comprises outputting an error if more than one function corresponding to the function call is present within the function library.

59. The computer readable medium of claim 40, wherein the method further comprises selecting the function library.
